(19) United States
(12) Patent Application Publication
(10) Pub. No.: US 2011/0029570 A1
(43) Pub. Date: Feb. 3, 2011

(54) SYSTEMS AND METHODS FOR CONTEXTUALIZED CACHING STRATEGIES

(75) Inventor: Christiaan Pretorius, Pretoria (ZA)

Correspondence Address: FOLEY AND LARDNER LLP;SUITE 500, 3000 K STREET NW, WASHINGTON, DC, 20007, US

(73) Assignee: Worldwide Objects International Limited

(21) Appl. No.: 12/533,609

(22) Filed: Jul. 31, 2009

(51) Int. Cl. G06F 17/30; G06F 7/00; G06F 12/00

(52) U.S. Cl. 707/797; 707/E17.014; 707/E17.044

(57) ABSTRACT

Systems, methods and devices for managing objects stored in memory are described. Information about the cached objects are stored in a tree structure that can be searched when a request for an object is made, in order to locate the object in memory. During or shortly after the search process, information about the search path through the tree is stored in a cache, and used to speed later searches for objects in memory.

### BACKGROUND

The present application is related to the field of systems and devices for data storage. More particularly, the present application presents systems, devices and methods for improving the speed of access of data in machine systems. Still more particularly, the present application is directed to systems, devices and methods for using a plurality of storage facilities of varying speeds to achieve a performance improvement for access and retrieval time for large amounts of data.

### SUMMARY

Certain embodiments presented in the application are summarized in the following list of optional embodiments:

A computerized system for managing a plurality of objects, comprising: a slower memory; a faster memory; a processor configured to perform a search using a tree structure comprising information relating to a plurality of objects; wherein the processor is configured to store in a cache memory information from at least one node of a tree encountered during the search.

The computerized system of paragraph [0003], wherein the tree structure is a B Tree.

The computerized system of paragraph [0003], wherein the tree structure is a B+ Tree.

The computerized system of paragraphs [0004] or [0005], wherein the processor is configured to store in a cache memory information from each node of a tree structure encountered during a search.

The computerized system of paragraph [0003], wherein the processor is configured to store in a cache memory information from each node of the tree structure encountered during a search.

The computerized system of paragraph [0003], wherein the processor is configured to perform a second search by accessing the cache memory and accessing a previously cached node of the tree structure as a starting point for the search.

The computerized system of paragraph [0008], wherein the processor is configured to perform the second search by first accessing the cache memory to retrieve information from a root node of the tree structure.

The computerized system of paragraph [0008], wherein the processor is configured to perform the second search by first accessing the cache memory to retrieve information from a most recently accessed leaf node of the tree structure.

The computerized system of paragraph [0008], wherein the processor is further configured to store, associated with each node of a tree, information relating to the part of the node that was most recently accessed.

The computerized system of paragraph [0009], wherein the processor is further configured to perform the second search by first accessing the cache memory to retrieve first information relating to a root node of the tree structure, accessing the root node or a copy thereof to locate second information closest to the first information, and using the results of that access to access a different node of the tree.

The computerized system of any of the preceding paragraphs, wherein the cache memory is comprised of a portion of the faster memory.

The computerized system of any of the preceding paragraphs, wherein the information stored in the cache relating to at least one node comprises a set of unique keys that is orderable, meaning that the keys of the set can be arranged such that they have a definite position within that set based on an ordering rule, and pointers to other nodes.

The computerized system of paragraph [0014], wherein the information stored in the cache relating to at least one node comprises, for at least some of the keys, an associated pointer to an object or set or page of objects stored in the faster memory.

The computerized system of paragraph [0014], wherein the information stored in the cache relating to the at least one node comprises, for at least some of the keys, an associated pointer to an object or set or page of objects stored in the faster memory.

The computerized system of paragraph [0016], wherein the associated pointer to an object or set or page of objects stored in the faster memory further has associated with it a pointer to an object that comprises information relating to the most recently accessed objects of the object or set or page of objects.

The computerized system of any of the preceding paragraphs, wherein the cache memory is comprised of a portion of the faster memory.

A computerized method for managing a plurality of objects stored in a faster memory and copied from a larger plurality of objects stored in a slower memory, comprising: forming a tree structure comprising a root node, a plurality of intermediate nodes and a plurality of leaf nodes, the nodes comprising information about the plurality of objects; performing a first search, for information relating to a first object, in the tree structure by accessing one or more nodes; storing information about the nodes accessed during the search in a cache; performing a later search, for information relating to a second object, in the tree structure by first accessing the cache to retrieve first information about a node that was accessed in a previous search; and performing an operation to determine whether the information about the first node retrieved from the cache can be used to speed the later search.

The method of paragraph [0019], wherein the first information about a node that was accessed in a previous search comprises information about the root node.

The method of paragraph [0020], wherein the tree structure comprises a B tree, and the operation to determine whether the information about the first node retrieved from the cache can be used to speed the later search comprises comparing a key to be located with a key stored from a previous search in the cache.

The method of paragraph [0019], wherein the first information about a node that was accessed in a previous search comprises information about a leaf node.

The method of paragraph [0022], wherein the tree structure comprises a B tree, and the operation to determine whether the information about the first node retrieved from the cache can be used to speed the later search comprises comparing a key to be located with a key stored from a previous search in the cache.

A machine-readable storage medium that comprises a plurality of instructions embedded therein, that when executed on a processor will cause a processor to perform a method for managing a plurality of objects stored in a faster memory and copied from a larger plurality of objects stored in a slower memory, comprising: forming a tree structure comprising a root node, a plurality of intermediate nodes and a plurality of leaf nodes, the nodes comprising information about the plurality of objects; performing a first search, for information relating to a first object, in the tree structure by accessing one or more nodes; storing information about the nodes accessed during the search in a cache; performing a later search, for information relating to a second object, in the tree structure by first accessing the cache to retrieve first information about a node that was accessed in a previous search; and performing an operation to determine whether the information about the first node retrieved from the cache can be used to speed the later search.

The machine-readable storage medium of paragraph [0024], wherein the first information about a node that was accessed in a previous search comprises information about the root node.

The machine-readable storage medium of paragraph [0025], wherein the tree structure comprises a B tree, and the operation to determine whether the information about the first node retrieved from the cache can be used to speed the later search comprises comparing a key to be located with a key stored from a previous search in the cache.

The machine-readable storage medium of paragraph [0024], wherein the first information about a node that was accessed in a previous search comprises information about a leaf node.

The machine-readable storage medium of paragraph [0026], wherein the tree structure comprises a B tree, and the operation to determine whether the information about the first node retrieved from the cache can be used to speed the later search comprises comparing a key to be located with a key stored from a previous search in the cache.

The computerized system of any of the preceding paragraphs paragraph, wherein the cache memory is comprised of a portion of the faster memory.

### BRIEF DESCRIPTION OF THE DRAWINGS

FIG. 1 is a block diagram of an example computer system that may be useful for implementing certain embodiments.

FIG. 2 illustrates various levels of storage for objects in a computer system.

FIG. 3 illustrates an example B tree structure.

FIG. 4 illustrates an example page structure having pointers to pages in a memory.

FIG. 5 illustrates an example cache structure, implemented in this Figure as a stack.

FIG. 6 illustrates the addition of information relating to an object stack to a page of pointers.

FIG. 7 illustrates a cache memory, shown in this Figure as stack, that stores pages.

FIG. 8 is a flow chart illustrating a method of managing access to an object that may be stored in faster memory.

FIG. 9 is a flow chart illustrating a method of managing access to an object using a cache memory, that may be organized as a stack.

FIG. 10 illustrates an example B+ tree.

FIG. 11 is a flow chart illustrating a method of managing access to an object using a B+ tree.

FIG. 12 is a flow chart illustrating a method of managing access to an object by accessing a root node in a tree structure.

### DETAILED DESCRIPTION OF EMBODIMENTS

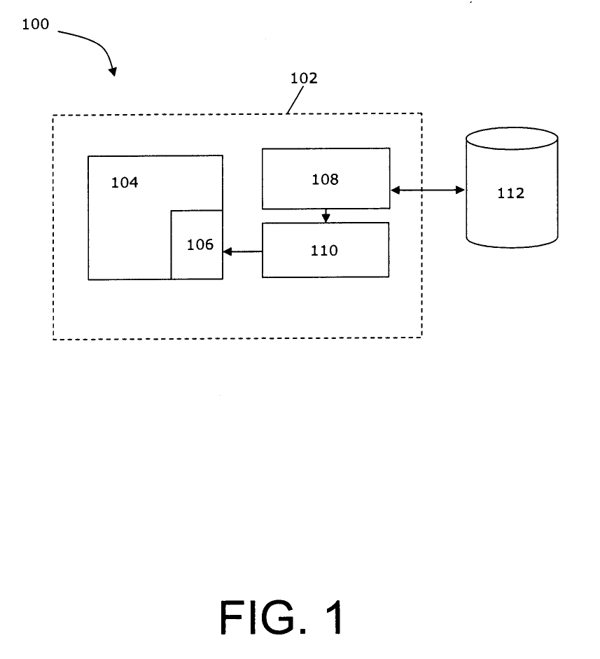

Referring now to FIG. 1, a system 100 in connection with which the teachings of the present application will be useful is shown. System 100 has, for example, a computer 102 having at least one processor 104, which may be a microprocessor, application specific integrated circuit, or other technology for manipulating data and processing instructions, whether programmable or programmed or hard-coded, or more than one of the previously named items. In particular, processor 104 can have access to a memory comprising a sequence of instructions which, when executed by processor 104, will cause the processor 104 and/or computer 102 to function as a system or device of the present application, or to carry out a method of the present application.

Processor 104 has access to varying forms of storage media 106, 108, 110 and 112, shown here as an on-chip cache 106, a fast off chip memory 110, a relatively slow off-chip memory 108, and an even slower storage system 112, which in many cases can be a large scale persistent storage system such as a hard disk, optical disk, RAID or other such device.

Often, the cost per Byte of storage of the systems 106-112 is inversely related to the speed of such systems. That is, while on-chip cache 106 is very fast in terms of access time, it is relatively expensive. Whereas storage 112 may be thousands of times slower to access, but far less expensive on a per Byte basis. Although the term “on-chip cache” is used in the context of FIG. 1 to mean memory integrated onto a chip-type processor, the broader term “cache” means a relatively faster memory or portion of memory for storing an amount of data that is less than the total amount of data in the system, to improve system efficiency. The “cache” of the present application can also, for example, be a portion of the faster memory described herein.

A system such as that shown in FIG. 1 may have a variety of different levels of such storage, where a level is defined by relative speed and cost. Each system can have strategies for managing the various levels of storage. These strategies can be managed by low-level systems that function transparently to a system user.

For the purposes of explaining the content of the present application, it is sufficient to consider two levels of storage, which will be referred to herein fast storage and slow storage. The fast storage in many cases will be a random access memory (RAM), that can be essentially any type, including DRAM, SRAM, SDRAM, Flash memory, etc. The slow storage in many cases will be a persistent high-volume storage, such as a disk drive or similar device.

The teachings of the present application will be particularly useful where large amounts of data are to be managed. This can occur in situations, for example, where a large application is being run, or where a large database is being managed. For example, the teachings of the present application are envisioned to be useful for managing databases that keep track of social services payments, genetic or medical traits for a large population of individuals, modeling data relating to portions of a physical object, large-scale inventory, etc. These data or the results of transformations performed thereon may be visually depicted and displayed, e.g., to a user.

Data to be managed may be stored as objects. In the present application, the term “object” is used to mean a discretely identifiable amount of data. An object may be, for example, an object as is known from object oriented programming languages, or quanta of data as stored in a database. Such objects may comprise data, data and metadata, data and code, code and metatdata, or data, code and metadata.

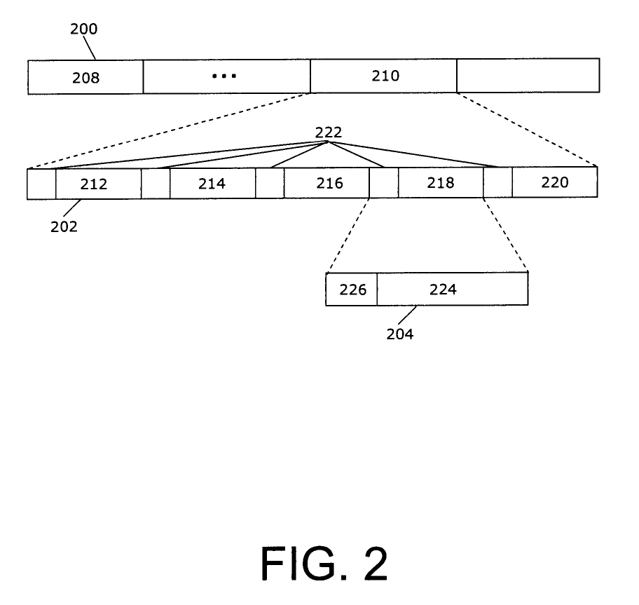

FIG. 2 shows objects in several storage forms. FIG. 2 has a slow storage section 200 for objects, part of which 202 may be extracted into faster storage, and from which objects such as 204 may be further extracted. Slow storage section 200 has pages of objects 208 and 210, which may be in various, non-sequential locations of slow storage section 200, that can be chosen by a local storage manager. The term “page” here means a collection of objects stored such that they can be accessed together, either because they are stored sequentially or logically related such that they can be accessed faster than a pure random access of each object. Each page such as 208 and 210 stored in slow storage section 200 will be referred to as c-page, because it may be compressed, although this is not a necessary aspect of the present application, or implied in the term “c-page”.

Section 202 is a page in fast storage as extracted from slow storage. The page 202 will be designated an “e-page”, because it may be expanded over its compressed form, although this is not a necessary aspect of the present application, or implied in the term “e-page”. The page 202 has a series of objects 212, 214, 216, 218, 220. The number of objects in the page 202 is shown as an example—it may be a high number of objects in larger systems. Each object can have an identifier, which can each be unique, but are shown in FIG. 2 as reference numeral 222.

Object 204 is an object that has been accessed from page 202, for example, such that the object can be used by an application. Object 204 is shown as having a payload 224 and an identifier 224. Object 204 is referred to as a d-object, because it may be decoded from objects in page 202, although this is not a necessary aspect of the present invention, nor implied in the term “d-page”. The encoding for objects in page 202 can include, for example, the storage of data in compact formats, for example, the storage of unicode characters as one byte entities, and/or the storage of identifiers as relative identifiers. For example, if identifiers are integers, the identifiers can be stored relative to the median identifier value.

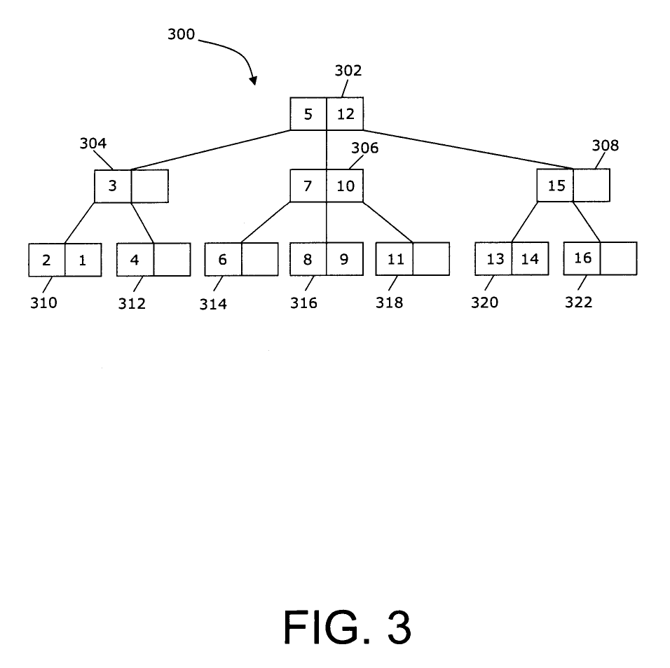

Pages 202 that are extracted from slow storage can be organized for access advantageously according to a methods hereinafter described. FIG. 3 shows a logarithmic search tree 300 (where search time scales as the log of the number of entries in the tree). The tree of FIG. 3 comprises nodes 302 through 322. Here the term “node” is used to mean a data structure, which may comprise elements that are logically associated by pointers, handles, codes or other methods, that is present in one level of a tree, and may have associations with parent and child nodes. There may be more than one node at some levels of a tree.

Tree 300 is an example of a B tree. The B tree 300 of FIG. 3 divides the set of integers from 1 to 16 for searching. The integers represent keys that can be easily compared. Each key is usually associated with a value that is bulkier or less easy to compare, and may be located in memory at a random location. A purpose of the search tree 300, then, is to facilitate finding values, by associating them with keys that are easy to evaluate, and organizing the keys in a manner that facilitates fast searching.

Suppose we wish to retrieve a particular value, known to be associated with the key X, where X is one of the integers from 1 to 16.To search the B tree to find a value associated with particular key X, a first comparison is made with key 5 in node 302. If X is less than 5,then node 304 is selected. If X equals 5,then the key has been located in the tree, and the associated value may be accessed. If X is greater than 5,then a comparison is made with the next key (12) in node 302. If X is less than 12,then node 306 is selected. If X equals 212,then the key has been located and the value may be retrieved. If X is greater than 12, then node 308 is selected. If one of nodes 304, 306 or 308 is selected, the process begins again at the respectively selected node. Eventually, the search process may reach one of the nodes 310-322, which have no children. These nodes are termed “leaf” nodes, while node 302 is the “root”.

The use of such a tree structure can dramatically reduce search times for pages stored in fast memory. An example may be illustrated as follows: Suppose that there are 1000 c-pages stored in slow storage, for example, on a hard disk. As these pages are accessed and decompressed to form e-pages, they are stored or cached in fast memory. Only a fraction of all c-pages will exist in memory as e-pages, however. A computer system wishing to access a particular object, must in this particular example first check whether the page is in memory. One way to do this is to search the memory for pages, and then compare the pages with some indicator of the correct page one-by-one. This tends to be slow, however. Therefore, it is advantageous to associated pages stored in memory with a key, and to use the keys to form a search tree such as the one shown in FIG. 3.

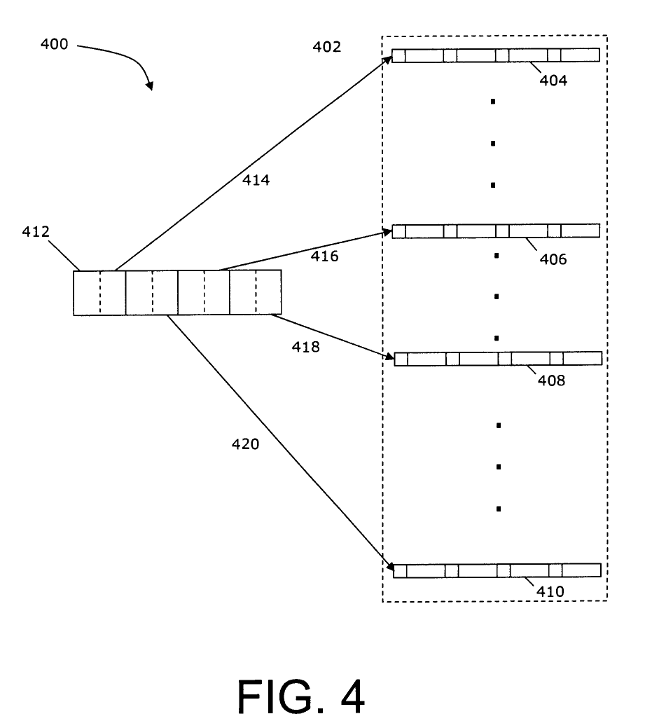

FIG. 4 illustrates one such system 400. System 400 has a fast storage 402, indicated by a dashed box, containing e-pages 404, 406, 408 and 410. Each e-page encompasses a number of objects. The pages may be stored at different points in fast storage 402, according to the rules governing the device manager driving the fast storage 402. In order to facilitate rapid location of the pages in memory, a location unit comprising a key and a pointer to the corresponding page is assembled. A p-page, such as p-page 412, is a group of such location units. P-page 412 comprises a four location units, each having a key, where each key is associated with one of four pointers 414, 416, 418 and 420, pointing to e-pages 404, 406, 408 and 410 respectively.

As c-pages are accessed and e-pages stored in memory, p-pages can be added to. When a p-page reaches a certain number of location units, it can be split into parent/child p-pages according to the rules governing search trees, and preferably, B Trees, and still more preferably, a B+ Tree. When adding elements, it can be advantageous to use a permutation buffer, such that elements in the search tree do not need to be reordered. With a permutation buffer, any insert to the search tree is inserted in the permutation buffer instead. The permutation buffer maps the key that was added to a different key in the search tree, typically the least costly key for performing an insert operation.

The search tree can then be searched to locate a particular e-page containing a desired object. Once the e-page is located in fast storage, it can be searched to retrieve a particular object that is desired.

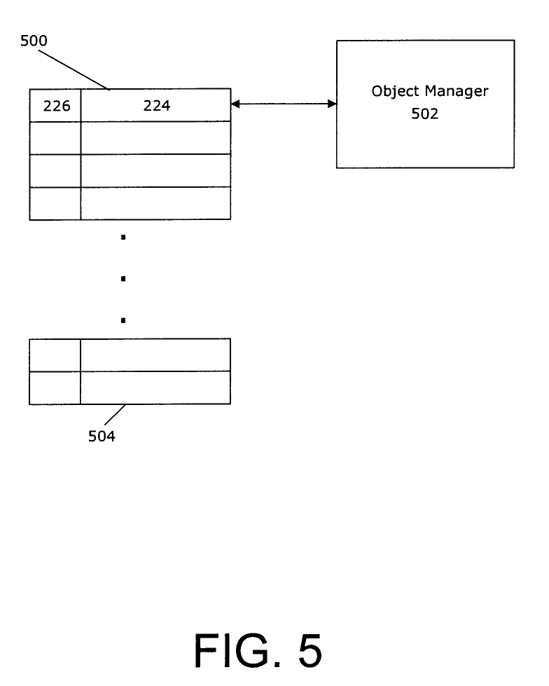

FIG. 5 shows an object management memory 500, illustrated here as a stack. In one embodiment, an object manager is responsible for managing a stack of objects that have been accessed for each page. Thus, stack 500 comprises a number of objects, each preferably having a payload 224 and an identifier 226. The stack has a root object 504. When an e-page is accessed, its stack can be checked for the most recent objects. This saves computation, to the extent that the likelihood of access to a particular object is a function of how recently it was last accessed.

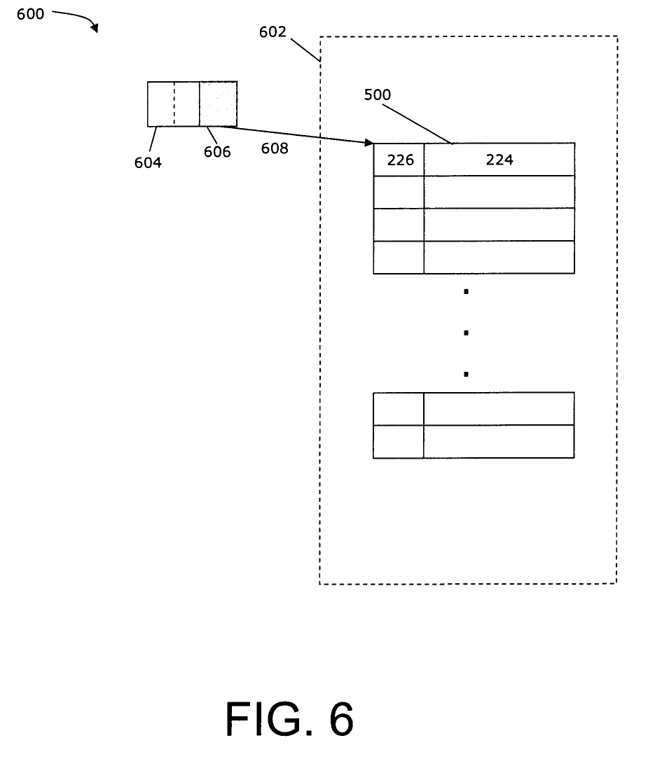

As shown in the example 600 of FIG. 6, the object stack 500 can exist in fast storage 602, and be associated with location unit 604, through data 606 representing a pointer 608 to object stack 500. In this manner, when a key is located in a search tree, both the e-page and its object stack can be retrieved directly.

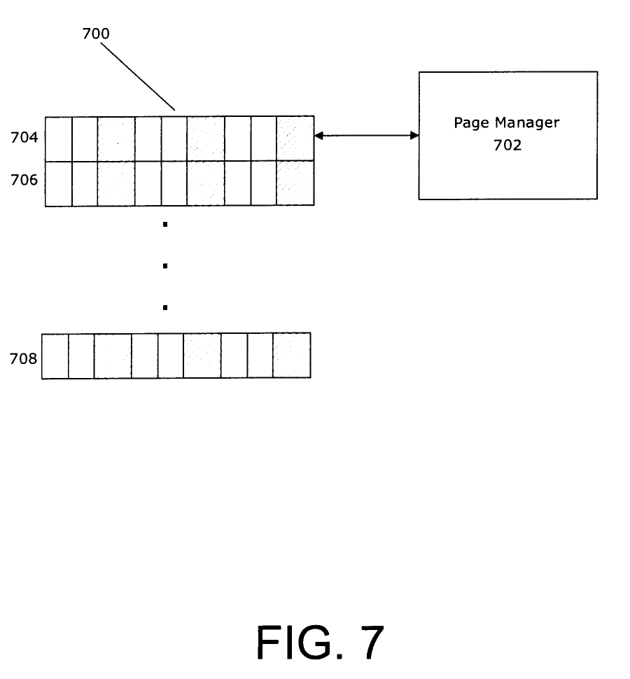

FIG. 7 illustrates the use of a second stack, here denoted an “active stack”, to manage p-pages with associated object stacks. A Page Manager 702 manages an area of memory 700 that may be configured as a stack. The stack comprises p-pages 704, 706 . . . 708, each having a plurality of location units and object pages associated therewith. These p-pages are also organized in memory as a search tree. Use of the stack 700 facilitates even faster searching through a search tree. In brief, when a p-page, that is, a node in a search tree, is accessed, it can be placed on the stack. In that way, information about the most recent search path through the search tree is stored, and can be used in certain situations to dramatically reduce search time.

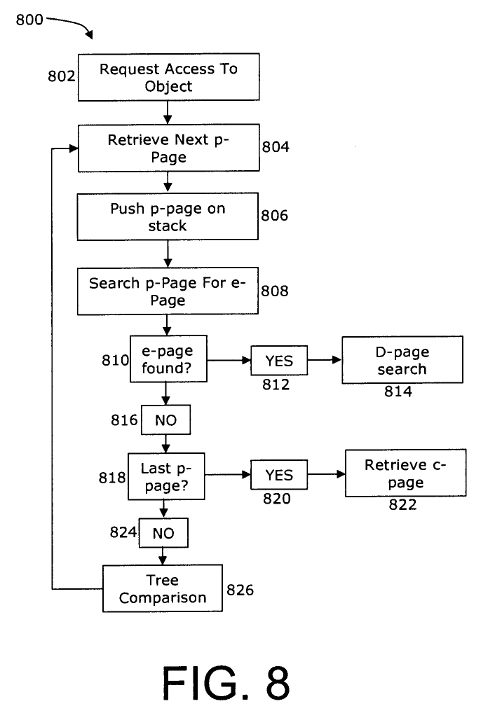

FIG. 8 shows a method 800 using a search tree and stack to speed retrieval of e-pages cached in fast storage. At step 802, an application requests access to a particular object, located in a known page in slow storage. In order to increase speed, the system will first check its search tree to see whether the page has been cached in fast storage. At step 804 a first p-page is accessed. Each p-page preferably contains a location unit, which is a key and a pointer to the e-page with which it is associated. The key may be, for example, an integer unique to that location unit, but may in principle be any orderable value.

Because this is the first attempt to access an object, the first p-page retrieved at step 804 corresponds to the root of the search tree. This p-page is pushed onto the stack at step 806, so that a search history can be maintained. At step 808, the keys in the p-page are compared with the key being sought to determine whether the corresponding e-page is represented in the retrieved p-page. This can be done by direct comparison, by the method as detailed with respect to FIG. 3, or by any other appropriate means. For example, if each p-page contains a large number of keys, a binary search or golden section approach may yield the best results.

In the process of searching the p-page, it is evaluated (step 810) whether the key corresponding to the desired e-page has been found, indicating the location of the e-page in fast storage. If the key has been found, (step 812), then the e-page can be searched for the specific object, possibly with the assistance of an object stack 500. If the key is not located (step 816), it is evaluated whether there are no more p-pages to be retrieved, corresponding to a “leaf” in the search tree. If so (step 820), then the corresponding c-page must be retrieved from slow storage.(step 822). If not (step 824), then the determination as to which p-page is to be retrieved is made, based on information obtained in step 808, and using, for example, the method described in relation to FIG. 3.

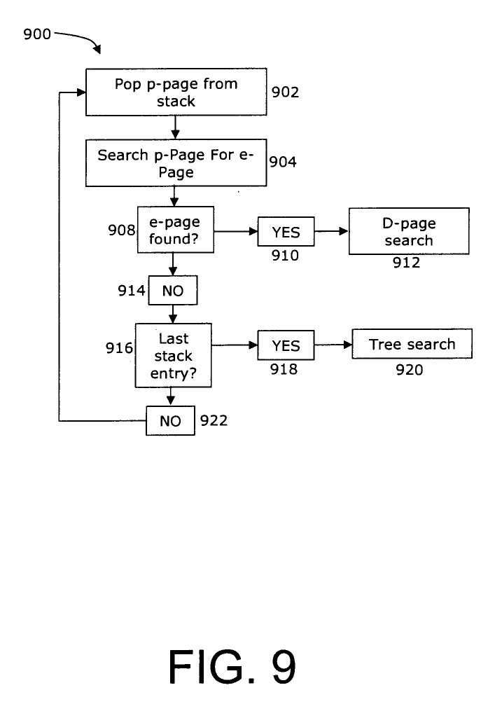

FIG. 9 shows a method 900 making advantageous use of a history for searching for the location of a page of objects in memory. It is assumed for method 900 that previous searches have been performed. At step 902, a p-page is popped from the top of a stack. This means that the most recently accessed p-page (the page where a desired key was found, or was closest to being found) is retrieved first. In many cases, this will result in starting at a leaf node in the search tree.

At step 904, this page is searched for the desired key using one of the methods described above. If it is determined (step 908) that the key has been found in that page (step 910), then a search of the objects within the corresponding e-page can commence. If the key is not found, it is determined whether there are further p-pages on the stack. If not (step 922), a new p-page is popped from the stack, and the method repeated. If so, however, (step 918) a normal tree search (step 920) is performed, according, for example, to FIG. 8. In this manner, data that is ordered in such a manner that accesses to nearby data are statistically likely can be rapidly located in memory.

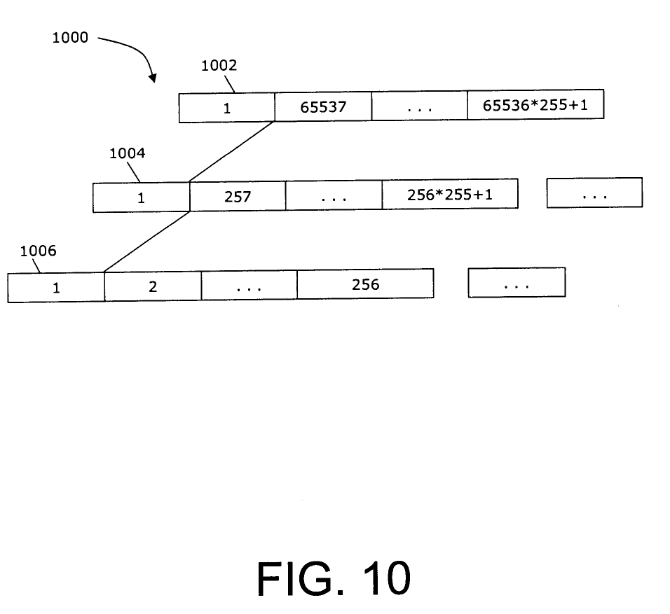

FIG. 10 shows a preferred tree arrangement 1000 for use in such systems. The tree arrangement is of order 256,meaning that each node that is not a leaf node can have 256 children. Furthermore, the values in each node are repeated in all descendent nodes (children, grandchildren, etc.). The tree 1000 is shown with three levels 1002, 1004 and 1006. The root level 1002 contains keys starting with 1 and increasing by 65526 or 2̂16. The middle level 1004 has 256 nodes, each with 256 entries, where each entry is 256 apart. The leaf level 1006 contains 65536 nodes, each with 256 entries, with consecutive integers occupying each subsequent position.

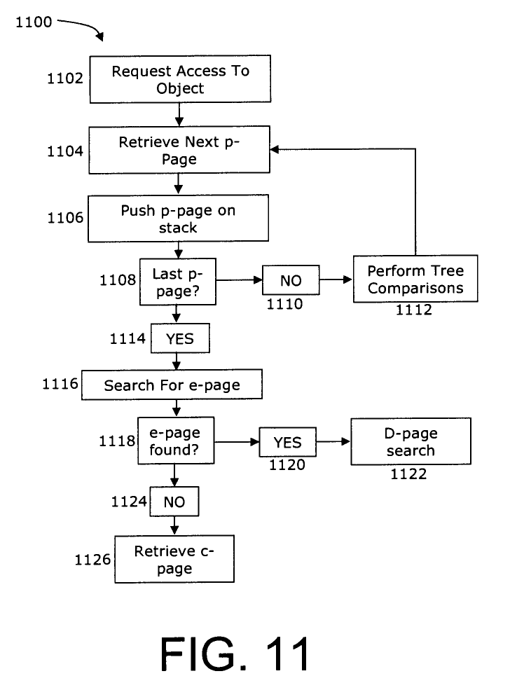

A method 1100 implementing a search using the search tree of FIG. 10 is illustrated in FIG. 11. At step 1102, an application requests a particular object known to reside in a particular c-page. First, a p-page is retrieved at step 1104 and pushed onto the stack to record the search path at step 1106. The current p-page is tested (step 1108) to determine whether it is a leaf page. If the p-page is not a leaf page (step 1110), then the correct next page is determined by performing greater than comparisons (step 1112) as described in reference to FIG. 3.

If the p-page is a leaf page, however (step 1114), a search for the e-page (step 1114) is undertaken. Because the tree structure shown in FIG. 10 contains all entries at the leaf level, checking for an exact match can wait until this level is reached. If the e-page is found at step 1120, then a search for the desired object within the e-page is undertaken. If not (step 1124), then the corresponding c-page is retrieved from slow memory.

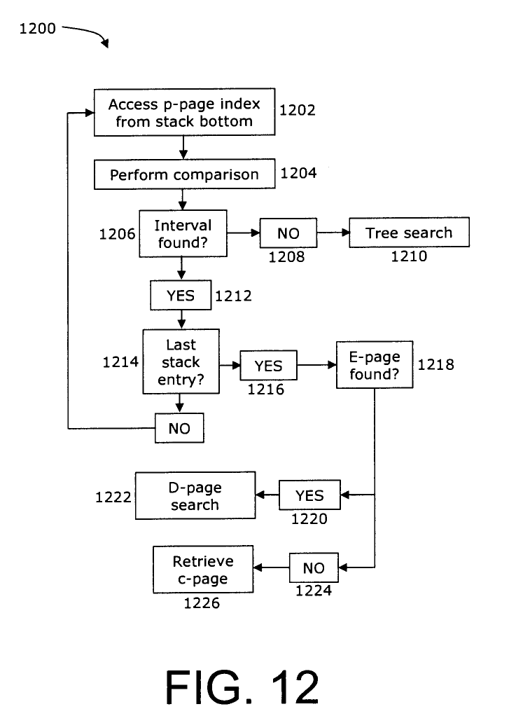

FIG. 12 illustrates a method 1200 for advantageously using a memory 700 with the search tree 1000 of FIG. 10. In step 1202, the search for a desired page and object begins by retrieving from the bottom of the active stack. The method can either retrieve the p-page one up from the root (second to last entry), or instead, associate with each entry on the active stack the result of previous searches within each p-page. For example, using the tree of FIG. 10, a previous search for the value 65538 using a greater than or equal to test, would generate a relative index of [2] for the stack, because it is greater than 65537, but not greater than 2*65536+1.This can be determined in a subsequent search by storing it with the stack, or by examining the next p-page up in the stack.

The p-page has been retrieved performs a comparison at step 1204 using the prior relative index. If the page is, for example, near the prior index, the number of comparisons can be cut dramatically. For example, it can be asked whether a new value is found between the relative indices [1] and [2] based on the prior result of [2]. This eliminates a fair number of comparisons that would be required in a binary search to come to the same result, if the data is near (in terms of key order) the most recently accessed data.

If the comparison of step 1204 does not find the correct interval (step 1208), then a normal tree search (step 1210) is performed. If the interval is found using stack results (step 1212), then it is determined whether the p-page is the last stack entry (step 1214). If not, then the next p-page is taken from the next highest position in the stack and the method repeated from step 1202. If so, however, the p-page is searched for the key corresponding to the desired e-page at step 1218, using a binary search or other method. If the desired key is located, then a search of the corresponding e-page for the desired object (step 1222) is commenced. If not (step 1224), then a c-page having the desired object is retrieved from slow storage. The method of FIG. 12 has been found to yield a surprising increase in performance for many data types over, for example, the method of FIG. 9. This includes many types of data where successive accesses happen on keys that have a low data distance, although the method of FIG. 9, by accessing the node of a tree from which an object was most recently located, might seem a more fruitful starting point.

An adjustment to the method of FIG. 12 can be made by storing the previous relative index found in a prior search for each p-page. So, for example, if a first search takes a first branch in the tree, and a second search takes a second branch, a third search hitting the same branch as the first search can use the search results stored with the pages of that branch as a first result around which to test for the desired key. So, for example, if a first search retrieves a p-page, runs comparisons, and determines that index [2] contains the closest key, this value [2] is stored with that p-page, so that next time the p-page is accessed, the value can be used, even if an intervening search did not hit that p-page, thus causing the stack to be cleared of that p-page.

The foregoing description of the preferred embodiments of the invention is intended to be illustrative only, and is not intended to limit the scope of the invention, which is recited in the following claims.

What is claimed is:

1. A computerized system for managing a plurality of objects, comprising:
a slower memory;
a faster memory;
a processor configured to perform a search using a tree structure comprising information relating to a plurality of objects;
wherein the processor is configured to store in a cache memory information from at least one node of a tree encountered during the search.

2. The computerized system of claim 1, wherein the tree structure is a B tree.

3. The computerized system of claim 2, wherein the tree structure is a B+ Tree.

4. The computerized system of claim 3, wherein the processor is configured to store in a cache memory information from each node of a tree structure encountered during a search.

5. The computerized system of claim 1, wherein the processor is configured to store in a cache memory information from each node of the tree structure encountered during a search.

6. The computerized system of claim 1, wherein the processor is configured to perform a second search by accessing the cache memory and accessing a previously cached node of the tree structure as a starting point for the search.

7. The computerized system of claim 6, wherein the processor is configured to perform the second search by first accessing the cache memory to retrieve information from a root node of the tree structure.

8. The computerized system of claim 6, wherein the processor is configured to perform the second search by first accessing the cache memory to retrieve information from a most recently accessed leaf node of the tree structure.

9. The computerized system of claim 6, wherein the processor is further configured to store, associated with each node of a tree, information relating to the part of the node that was most recently accessed.

10. The computerized system of claim 7, wherein the processor is further configured to perform the second search by first accessing the cache memory to retrieve first information relating to a root node of the tree structure, accessing the root node or a copy thereof to locate second information closest to the first information, and using the results of that access to access a different node of the tree.

11. A computerized method for managing a plurality of objects stored in a faster memory and copied from a larger plurality of objects stored in a slower memory, comprising:
forming a tree structure comprising a root node, a plurality of intermediate nodes and a plurality of leaf nodes, the nodes comprising information about the plurality of objects;
performing a first search, for information relating to a first object, in the tree structure by accessing one or more nodes;
storing information about the nodes accessed during the search in a cache;
performing a later search, for information relating to a second object, in the tree structure by first accessing the cache to retrieve first information about a node that was accessed in a previous search; and
performing an operation to determine whether the information about the first node retrieved from the cache can be used to speed the later search.

12. The method of claim 11, wherein the first information about a node that was accessed in a previous search comprises information about the root node.

13. The method of claim 12, wherein the tree structure comprises a B tree, and the operation to determine whether the information about the first node retrieved from the cache can be used to speed the later search comprises comparing a key to be located with a key stored from a previous search in the cache.

14. The method of claim 11, wherein the first information about a node that was accessed in a previous search comprises information about a leaf node.

15. The method of claim 14, wherein the tree structure comprises a B tree, and the operation to determine whether the information about the first node retrieved from the cache can be used to speed the later search comprises comparing a key to be located with a key stored from a previous search in the cache.

16. A machine-readable storage medium that comprises a plurality of instructions embedded therein, that when executed on a process will cause that processor to perform a method for managing a plurality of objects stored in a faster memory and copied from a larger plurality of objects stored in a slower memory, comprising:
forming a tree structure comprising a root node, a plurality of intermediate nodes and a plurality of leaf nodes, the nodes comprising information about the plurality of objects;
performing a first search, for information relating to a first object, in the tree structure by accessing one or more nodes;
storing information about the nodes accessed during the search in a cache;
performing a later search, for information relating to a second object, in the tree structure by first accessing the cache to retrieve first information about a node that was accessed in a previous search; and
performing an operation to determine whether the information about the first node retrieved from the cache can be used to speed the later search.

17. The machine-readable storage medium of claim 16, wherein the first information about a node that was accessed in a previous search comprises information about the root node.

18. The machine-readable storage medium of claim 17, wherein the tree structure comprises a B tree, and the operation to determine whether the information about the first node retrieved from the cache can be used to speed the later search comprises comparing a key to be located with a key stored from a previous search in the cache.

19. The machine-readable storage medium of claim 16, wherein the first information about a node that was accessed in a previous search comprises information about a leaf node.

20. The machine-readable storage medium of claim 19, wherein the tree structure comprises a B tree, and the operation to determine whether the information about the first node retrieved from the cache can be used to speed the later search comprises comparing a key to be located with a key stored from a previous search in the cache.
